(19) United States
(12) Patent Application Publication
(10) Pub. No.: US 2009/0183182 A1
(43) Pub. Date: Jul. 16, 2009

(54) Dynamic Composition of Virtualized Applications

(75) Inventors: Srivatsan Parthasarathy, Seattle, WA (US); Alan Chi-Hang Shi, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/972,597

(22) Filed: Jan. 10, 2008

(51) Int. Cl. G06F 13/00

(52) U.S. Cl. 719/321

(57) ABSTRACT

Various embodiments enable an application to be run on a computing device via dynamic composition of a virtual application image on a client device. The virtual application image is constructed using one or more application components retrieved from a local storage location and/or a remote resource, such as a network server. Each application component can be an independently serviceable unit that can be updated and/or replaced by any suitable entity, such as an independent software vendor, a network administrator, and so on.

### BACKGROUND

In most traditional computing scenarios, a full software application is first installed on a computer before the computer runs the application (i.e., the application is locally installed and executed). Local installation and execution of applications does not typically allow for application isolation, which can result in interferences between local applications, such as resource conflicts. In these scenarios, servicing or updates to a particular application are typically performed on each computer on which the application is installed. While servicing or updating an application can cause minor annoyance to individual application users, such tasks present a major cost issue to a large-scale user of an application, such as an enterprise network with a large number of user nodes. In enterprise network scenarios, when an update or patch is issued for an application, the update or patch will typically need to be installed on every user node (e.g., client computer) on which the application is installed. This imposes a resource burden on a network administrator and the enterprise itself.

In an attempt to overcome some of the problems presented with local installation and execution of applications, the technique of virtualization was developed. Virtualization refers generally to the process of creating namespace isolation between different applications. To implement virtualization, an application is installed into a virtual environment, and the installed application is then captured as an image that can be deployed to individual nodes on a network. This technique creates its own problems in that different application images may utilize the same shared components. If an update for a shared component is issued, every application image that utilizes the shared component is serviced to implement the update. As with local installation and execution of applications, virtualization alone can present a burden on network resources.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable an application to be run on a computing device via dynamic composition of a virtual application image on a client device. The virtual application image is constructed using application components retrieved from a local storage location and/or one or more remote resources, such as a network server. Each application component can be an independently serviceable unit that can be updated and/or replaced by any suitable entity, such as an independent software vendor, a network administrator, and so on.

### BRIEF DESCRIPTION OF THE DRAWINGS

The same numbers are used throughout the drawings to reference like features.

FIG. 1 illustrates an operating environment in which various principles and techniques described herein can be employed in accordance with one or more embodiments.

FIG. 2 illustrates an operating environment in which various principles and techniques described herein can be employed in accordance with one or more embodiments.

FIG. 3 is a flow diagram of a process that utilizes various principles and techniques described herein in accordance with one or more embodiments.

FIG. 4 is a flow diagram of a process that utilizes various principles and techniques described herein in accordance with one or more embodiments.

### DETAILED DESCRIPTION

Overview

Various embodiments enable an application to be run on a computing device via dynamic composition of a virtual application image on a client device. In some embodiments, the dynamic composition of the virtual application image can occur at application runtime. The virtual application image is constructed using one or more application components retrieved from a local storage location and/or a remote resource, such as a network server. Each application component can be an independently serviceable unit that can be updated and/or replaced by any suitable entity, such as an independent software vendor, a network administrator, and so on.

In one implementation, a user of a computing device launches an application on the computing device. The computing device locates an application manifest for the application that describes the application components to be used to construct an application image for the application. Each application component is associated with a component manifest that describes resources and other requirements for running an application on the computing device. The computing device then locates the application components to be used to construct the application image. The application components can be stored locally on the computing device and/or at a remote resource. In some embodiments, one or more of the application components can be shared among multiple applications and can thus be used in the composition of multiple different application images. An application image is then constructed on the computing device using the application components. The application image creates a virtual application environment on the computing device that mimics a full application install. The application can then be run on the computing device in a virtual application environment using the application image and without having to actually install the application on the computing device.

In the discussion that follows, a section entitled “Operating Environments” is provided and describes two environments in which one or more embodiments can be employed. Following this, a section entitled “Example Processes” is provided and describes two processes that can implement various principles and techniques discussed herein.

Operating Environments

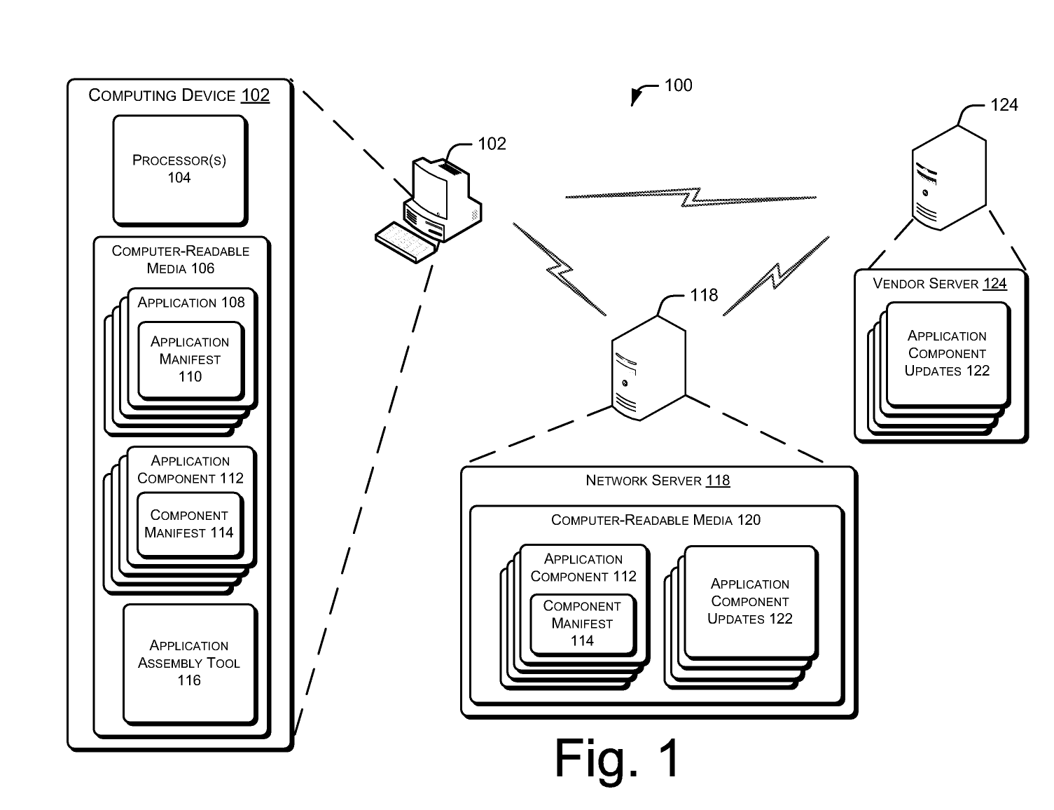

FIG. 1 illustrates an operating environment in accordance with one or more embodiments, generally at 100. Environment 100 includes a computing device 102 having one or more processors 104, one or more computer-readable media 106 and one or more application(s) 108 that reside on the computer-readable media and which are executable by the processor(s). Computing device 102 can be embodied as any suitable computing device such as, by way of example and not limitation, a desktop computer, a portable computer, a handheld computer such as a personal digital assistant (PDA), cell phone, and the like.

Computer-readable media 106 can include, by way of example and not limitation, volatile media (such as random access memory (RAM)) and/or nonvolatile media (such as read only memory (ROM), Flash memory, optical disks, magnetic disks, and so forth). Computer-readable media 106 can include fixed media (e.g., RAM, ROM, a fixed hard drive, etc.) as well as removable media (e.g., a Flash memory drive, a removable hard drive, an optical disk, and so forth). Application(s) 108 can include an executable or any other suitable file or application representation that can be used to initiate the composition of an application image on computing device 102. Application(s) 108 can be associated with a graphical icon on a desktop and/or interface displayed on computing device 102 that enables a user the initiate the application(s) by selecting the graphical icon using a mouse and pointer or any other suitable input/output device.

In addition, computing device 102 includes one or more application manifests 110. In some embodiments, each application is associated with its own application manifest. An application manifest describes a group of application components that can be used to construct an application image on computing device 102. An application manifest can also specify references to language-specific application components and information about where and/or how the language-specific application components can be located to comply with a user's regional settings and/or language preference(s). For example, an application manifest can specify application components composed in a language and/or languages that are appropriate for a user's regional settings (e.g., the user's geographical location and/or the user's language(s) of preference). In one example, an application manifest can specify a particular component, a version identifier for the component (e.g., version 2.0.0.1), a default language for the component (e.g., English, Hangul, and so on), but can also contain a “wildcard” language reference that allows for other languages to be substituted for the default language based on a user's location and/or language preference(s). Thus, an application manifest can specify a loose dependency on a user's regional and/or language settings, allowing application components to be located that comply with these settings, or substituting a default setting if an application component cannot be located that complies with the user settings and/or preferences. This enables application images for a particular application to be constructed for multiple different users with varying language preferences using a single application manifest, with the default language being used if an application component cannot be located that matches a user's location and/or language preference(s). Thus, additional languages can be specified for an application (e.g., Chinese, French, Spanish, and so on) without requiring modification of the application manifest. The single application manifest can be used to create an application image in any suitable language.

An application manifest can also specify application components based on a particular processor, a specific operating system, and/or a particular operating platform resident on or supported by a computing device that is running the application. Thus, an application manifest can specify that a version of an application component be located that is appropriate for a user's location and/or language preference(s), a computing device processor, a particular operating system, and so on.

Computing device 102 also includes a plurality of application components 112. An application component can include executable code and/or script that can be combined with other application components to construct an application image. An application component can be a component object model (COM) object and can include its own device configuration settings, interfaces, and so on.

Each application component 112 includes a component manifest 114. This is not intended to be limiting, however, and some application components may not include a component manifest. According to some embodiments, a component manifest provides information for the application component with which it is associated. This information can include a name for the component, a list of other application components upon which the application component is dependent (if any), a version designation for the component, a language description for the component (i.e., the computer language in which the component was created), and so on. The component manifest can also describe other files (e.g., application components), COM objects, registry keys, resources, and computing device settings for an application and/or application image. The component manifest can indicate if its associated application component is related to any other application components and, if so, the nature of the relationship (e.g., the application component requires a different application component in order to achieve the desired application component functionality). In some implementations, this information can be in the form of application component metadata.

A component manifest can be created by the entity that created the associated software component (e.g., a software vendor). Some application components are configured to be utilized to create a variety of different application images, each application image corresponding to a different application. For example, an application component that provides printing functionality can be used by both a word processing application and a spreadsheet application.

Computing device 102 also includes an application assembly tool 116 that is configured to process an application manifest and determine the application components specified by the application manifest. The application assembly tool can determine where the application components are located and can retrieve the application components. In some embodiments, one or more of the application components can be located at a remote resource, and the application assembly tool can submit a request to the remote resource for the one or more application components located at the remote resource. Application assembly tool 116 can also ensure that a proper version of an application component is supplied in response to a request for the application component (e.g., from computing device 102). Thus, in one embodiment, an application manifest and/or a component manifest can identify a specific version of an application component that is to be used to construct an application image. For example, if one version of an application component is labeled as “Version 1.1” and a second, newer version is labeled “Version 1.2”, an application and/or component manifest can specify that application component “Version 1.2” is to be used to construct an application image. In another embodiment, an application manifest can specify that the most current version of a certain application component is to be used to construct an application image, and application assembly tool 116 can examine available versions of the application component and supply the most recently updated version. Application assembly tool 116 can also communicate with a remote resource to determine if an updated version of an application component exists at the remote resource.

In scenarios where an application manifest specifies a particular language and/or operating platform for an application component, application assembly tool 116 can also search for one or more application components that match the language and/or platform specifications. As mentioned above, however, an application manifest need not specify a particular language, but can allow application components to be located based on a user location and/or user language preference(s). Application assembly tool 116 can also search for application components based on user-provided application configurations and administrator-provided application configurations.

Environment 100 also includes a network server 118. Network server 118 can be embodied as a suitable computing device such as, by way of example and not limitation, a standalone server, a server cluster, and so on. Network server 118 includes a computer-readable media 120 that can store various modules that implement various aspects of the processes and techniques described herein. Computer-readable media 120 can include, by way of example and not limitation, any of the computer-readable media discussed above with respect to computer-readable media 106. Stored on computer-readable media 120 are one or more application components 112 and one or more component manifests 114. As discussed above, computing device 102 can retrieve an application component from a local storage location or a remote storage location, such as network server 118.

Also stored on network server 118 are one or more application component updates 122. Application component updates 122 can include updated versions of application component(s) 112. In some embodiments, when an updated version of an application component is available, the updated version is pushed out to a computing device that has a previous version of the application component. In other embodiments, a computing device can submit a request for an application component update. For example, when application assembly tool 116 is assembling a group of components to create an application image, the application assembly tool can submit a query to determine if an updated version of one or more of the application components is available. The query can be submitted to a storage location local to the computing device, or to a remote resource such as network server 118. Application assembly tool 116 can then use the updated version of the application component to assemble an application image.

Also included in environment 100 is a vendor server 124. Vendor server 124 can be associated with a software vendor that creates application components for an application. In some embodiments, a primary software developer can develop an application, and an independent software vendor can develop application components that can be used in constructing an image of the application on a computing device. Thus, vendor server 130 can be associated with a primary software vendor and/or an independent software vendor. Software vendors can be considered independent of each other when each software vendor is a separate business concern from another software vendor.

Vendor server 124 can store one or more application components (such as application component(s) 112) and one or more application component updates 122. In some embodiments, computing device 102 and/or network server 118 can communicate with vendor server 124 to determine if an updated version of an application component is available from the vendor server. In one implementation, when an application component update becomes available from vendor server 124, the update can be pushed to computing device 102 and/or network server 118.

Although not expressly illustrated here, the devices and/or components discussed herein can be connected to and communicate via a network. Any suitable network can be utilized, such as a local access network (LAN), a wide area network (WAN), the Internet, and so on.

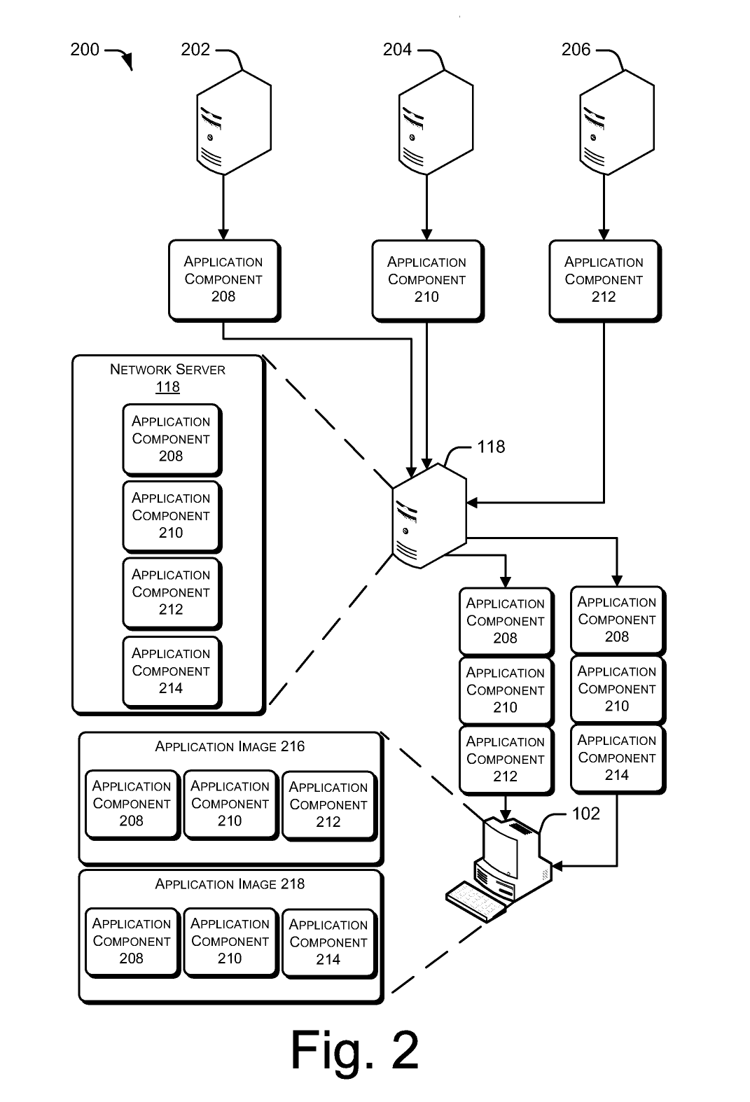

FIG. 2 illustrates an operating environment in accordance with one or more embodiments, generally at 200. Operating environment 200 is discussed generally with reference to operating environment 100. Operating Environment 200 includes a software vendor 202, a software vendor 204, and a software vendor 206. In this example, software vendor 202 produces an application component 208, software vendor 204 produces an application component 210, and software vendor 206 produces a software component 212. In some implementations, each software vendor is an independent entity (e.g., an enterprise independent from the other software vendors) that creates one or more software components. Thus, each software vendor can create custom components for an application and can provide updates for a software component. Each of software components 208-212 is a different software component that can be combined with other software components to produce one or more different application images.

In operation, network server 118 receives application components 208-212 from software vendors 202-206 and stores the application components on the server. One or more of application components 208-212 can include an updated version of an application component previously stored on network server 118. The application components and/or application component updates can be pushed from the network server to computing device 102. Additionally and/or alternatively, computing device 102 can pull an application component and/or application component update from network server 118 to the computing device. In some implementations, computing device 102 can receive application components and/or application component updates from a software vendor or a software developer.

As discussed above, an application component can be associated with a component manifest that specifies, among other things, what information the application component contributes to produce an application image. An administrator of network server 118 can interact with application components 208-212 to produce customized versions of the components. The administrator can also create a customized component manifest for a particular application component to specify application component behavior in creating an application image. The customized component manifest can provide configuration and/or deployment behavior that overrides and/or supplements the behavior specified in the original application component manifest.

When a user of computing device 102 launches an application (e.g., by selecting an application icon), computing device 102 submits a request for application components 208-212. In some embodiments, computing device 102 formulates this request based an application manifest associated with the application. As discussed above, the application components can be retrieved locally and/or remotely (e.g., from network server 118). As shown by application component 214, network server 118 and/or computing device 102 can store application components that may not be used in creating a particular application image, but may be used in creating a different application image. Based on an application manifest and the component manifests computing device 102 composes an application image 216 that includes application components 208-214 (but not application component 214).

Application image 216 enables the application to be run on computing device 102 in a virtual application environment, with the application manifest and/or component manifest(s) providing application and/or device configuration settings. Thus, the application can be run on computing device 102 in a virtual environment (e.g., the files and registry keys can be virtualized) and without requiring installation of the application on the computing device, thereby minimizing conflicts that can arise when an application depends on device configuration settings and other applications or components installed on the computing device. In some embodiments, computing device 102 can cache application image 216, thus allowing the application to be run from the image if the application is launched at a later time.

In another implementation, a user of computing device 102 can select a different application for execution. The computing device locates an application manifest for the different application, and based on the application manifest, requests application components 208, 210, and 214. Using these application components, an application image 218 is constructed on computing device 102. Application image 218 uses some of the same application components used to construct application image 216, but application image 218 corresponds to a different application than application image 216. As illustrated, a single application component can be used to construct a plurality of different application images, each corresponding to a different application. For purposes of example only and not limitation, application image 216 can correspond to a word processing application and application image 218 can correspond to a graphics editing application. These are merely examples, and an application image can correspond to any suitable application.

Example Processes

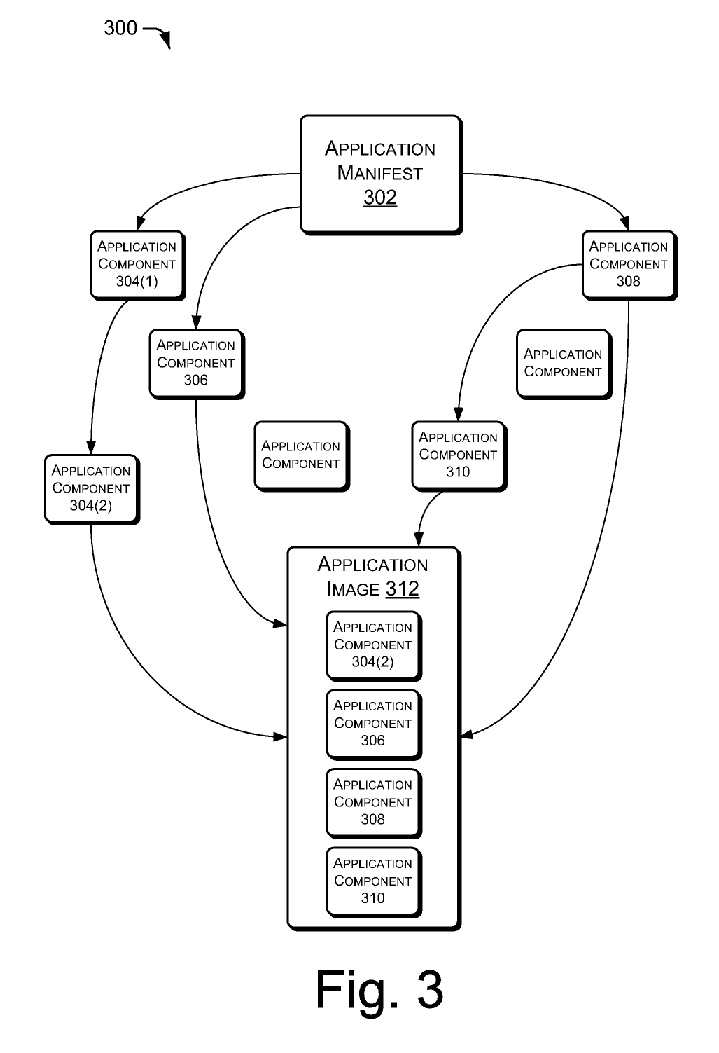

FIG. 3 illustrates at 300 one example of a process for the construction of an application image using a plurality of application components. The process can be implemented in connection with any suitable hardware, software, firmware, or combination thereof. As part of process 300, an application manifest 302 specifies a group of application components to be used to construct an application image. As shown by the arrows, application manifest 302 specifies application components 304(1), 306, and 308. Similarly to a component manifest, a customized version of an application manifest can be created (e.g., by a network administrator), the customized version of the application manifest providing configuration and/or deployment behavior that overrides and/or supplements the behavior specified in the original application manifest.

Also shown here is a pointer from application component 304(1) to an application component 304(2). Application component 304(2) is an updated version of application component 304(1). Application manifest 302 specifies that the most recently updated version of an application component is to be used to compose an application image. Application manifest calls for application component 304(1) to be used to construct an application image, and the process determines that an updated version of the application component is available (e.g., via application assembly tool 116). The updated version of the application component (i.e., application component 304(2)) is then used to construct the application image.

Also shown in process 300 is a pointer from application component 308 to an application component 310. This indicates that individual application components can include pointers to other application components that are to be used to construct an application image. In some examples, an application component can point to another application component that is not specified or otherwise indicated in an application manifest. In this example, the pointer to the other application component can be included in the component manifest that is associated with application component 308.

Process 300 includes an application image 312 that is constructed using the group of application components indicated by application manifest 302 and its associated application components. Thus, the application image includes application components 304(2), 306, 308, and 310. As illustrated in process 300, the process of constructing an application image can be guided by a variety of rules and/or policies. Among these are rules/polices that allow individual application components to include pointers to other application components, and that allow a request for an application component to be fulfilled by a newer version of the application component, if a newer version is available.

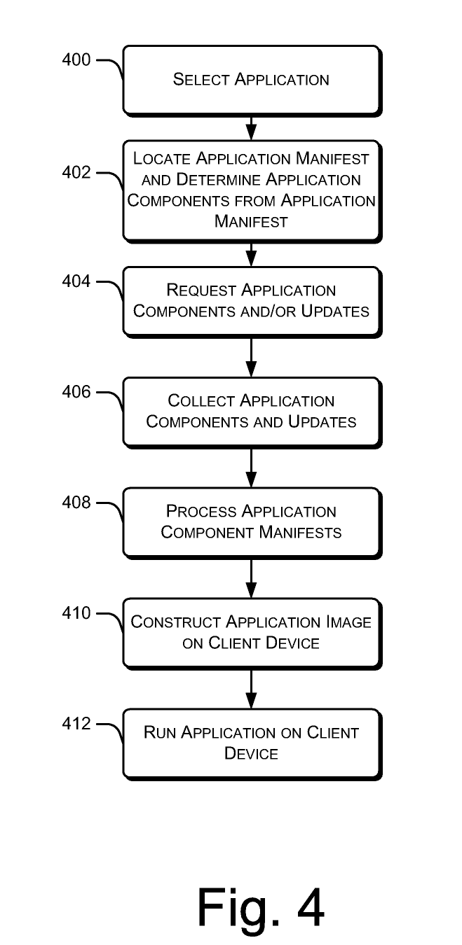

FIG. 4 is a flow diagram that describes acts in a process in accordance with one or more embodiments, and is discussed with reference generally to operating environments 100 and 200. The process can be implemented in connection with any suitable hardware, software, firmware, or combination thereof.

At 400, a user selects an application to run on a computing device by submitting a request to launch the application. User selection of the application can include input from the user that specifies an application that is to be run on the computing device. At 402, the computing device receives the request to launch the application, locates an application manifest for the application, and determines based at least in part on the application manifest what application components are to be used to create an application image for the application. At 404, the computing device requests the application components and, if available, updates for the application components. The application components and/or updates can be requested from a local storage location and/or from a remote resource (e.g., network server 118). At 406, the application components and application component updates (if available) are collected on the computing device. In some embodiments, the client device can choose to utilize updated versions of application components or it can be configured to obtain previous versions of application components. For example, a particular user may wish to run a legacy version of an application, or a network administrator may determine that a previous (i.e., not updated) version of an application component provides more desirable functionality than an updated version.

At 408, the computing device processes the component manifest(s) to determine configurations and/or settings provided by the component manifest(s). At 410, an application image of the application is created on the computing device using the application components and, if appropriate, updated versions of application components.

At 412, the application is run on the computing device from the application image. Thus, the application image creates a virtual application environment on the computing device that enables the application to be run on the computing device without installing the application on the computing device.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer-readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments enable an application to be run on a computing device via dynamic composition of a virtual application image on a client device. The virtual application image is constructed using one or more application components retrieved from a local storage location and/or a remote resource, such as a network server. Each application component can be an independently serviceable unit that can be updated and/or replaced by any suitable entity, such as an independent software vendor, a network administrator, and so on.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a request at a client device to launch an application;
locating an application manifest for the application, the application manifest designating a plurality of application components to be used to launch the application, each of the plurality of application components being associated with a component manifest that describes how the application component is to be implemented to construct an application image;
retrieving the plurality of application components, at least one of the plurality of application components being configured to be shared among multiple different applications; and
constructing the application image on the client device, the application image including the plurality of application components and being configured to run the application on the client device without installing the application on the client device.

2. A method as recited in claim 1, wherein the acts described therein are effective to dynamically compose the application image at an application runtime.

3. A method as recited in claim 1, wherein the application manifest specifies that at least one of the plurality of application components be retrieved based at least in part on a user's regional settings, and wherein retrieving the plurality of application components comprises retrieving one or more application components that correspond to the user's regional settings.

4. A method as recited in claim 1, wherein at least one of the plurality of application components is retrieved from a resource remote from the client device.

5. A method as recited in claim 1, wherein in an event that an updated version of an application component is available, the updated version of the application component is made available to the client device.

6. A method as recited in claim 1, wherein at least one of the component manifests references a further application component that is to be used to construct the application image, wherein the further application component is not designated in the application manifest.

7. A method as recited in claim 1, wherein the plurality of application components includes a first application component created by a first software vendor and a second application component created by a second software vendor, the first software vendor being independent from the second software vendor.

8. A method as recited in claim 1, further comprising running the application from the application image on the client device without installing the application on the client device.

9. A method comprising:
receiving, at a resource remote from a client device, a request for a plurality of application components, the request being generated based at least in part on an application manifest stored on the client device, the application manifest specifying a collection of application components to be used to construct an application image, and the application image being configured to allow an application to be executed on the client device without installing the application on the client device; and
providing the plurality of application components to the client device, at least one of the plurality of application components being associated with a component manifest, the component manifest including metadata that includes a version description for the application component.

10. A method as recited in claim 9, wherein the plurality of application components includes a first application component created by a first software vendor and a second application component created by a second software vendor, the first software vendor bring independent from the second software vendor.

11. A method as recited in claim 9, wherein providing the plurality of application components to the client device comprises determining if an updated version of at least one of the plurality of application components is available.

12. A method as recited in claim 9, wherein the component manifest further includes client device settings for executing the application on the client device.

13. A method as recited in claim 9, wherein at least one of the plurality of application components is configured to be utilized to construct application images for two or more different applications.

14. A method as recited in claim 9, further comprising:
receiving, at the resource remote from the client device, and updated version of at least one of the plurality of application components; and
providing the updated version to the client device.

15. A system comprising:
one or more processors;
one or more computer-readable media storing a plurality of modules capable of being executed by the one or more processors, the modules comprising:
an application manifest to specify a plurality of application components for running an application on a client device, the application components being retrieved at an application runtime;
a component manifest associated with at least one of the plurality of application components, the component manifest including a version description for the application component; and
an application image constructed on the client device from the application components, the application image being configured to run the application on the client device without installing the application on the client device.

16. A system as recited in claim 15, wherein the system is effective to dynamically compose the application image at the application runtime.

17. A system as recited in claim 15, wherein at least one of the plurality of application components is configured to be used to construct application images for two or more different applications.

18. A system as recited in claim 15, wherein each of two or more of the plurality of application components is configured to be independently updated.

19. A system as recited in claim 15, wherein the component manifest references a further application component to be used to run the application on the client device, and wherein the further application component is not referenced by the application manifest.

20. A system as recited in claim 15, wherein the modules further comprise:
an application assembly tool configured to determine if an updated version of an application component requested by the client device is available.
